(19) United States
(12) Patent Application Publication
(10) Pub. No.: US 2024/0100550 A1
(43) Pub. Date: Mar. 28, 2024

(54) SPRAY GUN NOZZLE

(71) Applicant: Carlisle Fluid Technologies (UK) Ltd., Dorset (GB)

(72) Inventors: Neil Bambrey, Dorset (GB); Andrew Stephen Gries, Perrysburg, OH (US)

(21) Appl. No.: 18/531,050

(22) Filed: Dec. 6, 2023

Related U.S. Application Data
(63) Continuation of application No. 17/262,345, filed on Jan. 22, 2021.

(30) Foreign Application Priority Data
Jul. 24, 2018 (GB) 1812072.5

(51) Int. Cl. B05B 7/06; B05B 7/08

(52) U.S. Cl. CPC B05B 7/066; B05B 7/0815

(57) ABSTRACT

An air-cap nozzle 103b for discharging an atomising air jet 101b for atomising paint from a spray gun, the air cap nozzle comprising a tip surface having an atomizing air outlet 100b and a rim region 102b surrounding the outlet. The rim region 102b comprises a continuous serrated portion formed by a plurality of protrusions 104 that protrude axially outward from the rim region 100b of the tip surface. The protrusions 104 are separated by valleys 105 configured to permit entrainment of ambient air by the atomising air jet 101b, the entrained ambient air being drawn through the valleys. The permitted entrainment provides mixing between the entrained ambient air and the atomising air jet 101b.

### CROSS REFERENCE TO RELATED APPLICATIONS

This application is a continuation of pending U.S. Ser. No. 17/262,345, filed 22 Jan. 2021, which was a Section 371 national stage application of International Application No. PCT/GB2019/052023, filed 19 Jul. 2019, which claims priority from Great Britain Application 1812072.5, filed 24 Jul. 2018, which applications are incorporated herein by reference.

### FIELD OF THE INVENTION

The invention relates to paint spray-guns. More specifically, the invention relates to air cap nozzles for use with paint spray-guns.

### BACKGROUND

Paint spray guns are often used to apply paint to a medium such as a vehicle body panel. Paint spray guns usually include a means for breaking down the liquid paint into small particles (i.e. a spray) before it is applied to the medium. This process is called atomisation. Atomisation is achieved by mixing a paint jet and an “atomising” air jet. The mixing between these jets causes atomisation.

Existing paint spray guns include a fluid tip that comprises an air cap and a paint nozzle. The air cap provides a jet of atomising air from an air cap outlet that is proximal to the paint nozzle thereby enabling the necessary mixing between the jets for atomisation of the paint. A high pressure air source is often used to provide the jet of atomising air.

It is desirable for the atomising air jet to have a high velocity. However the high velocity atomising air jets generated by existing paint spray guns cause undesirable noise. Furthermore, existing paint spray guns are susceptible to causing fluctuations (so called “flapping”) of the atomising air jet that decrease the transfer efficiency of the spray gun (i.e. the number of paint droplets adhering to a surface).

WO2007104967A1 discloses a spray head for a multiple fluid atomiser spray gun that has a spray delivery face, a main fluid delivery nozzle and one or more atomising fluid delivery orifices. U.S. Pat. No. 3,146,3395A discloses an atomizing head for paints, varnishes or other liquids comprising a nozzle positioned coaxially within an orifice of a spherical cap.

### SUMMARY

According to the invention there is provided an air cap nozzle for discharging an atomising air jet for atomising paint from a spray gun, the air cap nozzle comprising a tip surface having an atomising air outlet and a rim region surrounding the outlet. The rim region comprises a single continuous serrated portion formed by a plurality of protrusions that protrude axially outward from the rim region of the tip surface. The protrusions are separated by valleys configured to permit entrainment of ambient air by the atomising air jet, the entrained ambient air being drawn through the valleys. The permitted entrainment provides mixing between the entrained ambient air and the atomising air jet. The continuous serrated portion forms a trailing edge that impinges with the atomising air jet.

When atomising air is discharged from existing air cap nozzles, a mixing layer is created at the interface between the discharged air and the ambient air. The inventor has determined that this mixing layer is characterised by intense turbulence due to the high pressure and velocity differences between the discharged and ambient air. The intensity of this turbulence is directly related to generated noise levels. In order to reduce the operational noise, the turbulence of the mixing layer must be reduced.

The plurality of protrusions are found to reduce turbulence in the mixing layer by introducing stream-wise vortices that enhance mixing between the discharging airjet and the ambient air. This enhanced mixing reduces a peak velocity within the discharged air flow more quickly thereby reducing the amount of turbulence and the peak noise generated.

A further advantage is that the air cap nozzle of the invention is found to provide a particularly stable discharged atomising air jet due to the stream-wise vortices that are generated by the plurality of protrusions. The discharged atomising air jet is found to be more stable than that provided by existing air cap nozzles. Increased stability of the atomising air jet reduces the frequency and/or altitude of fluctuations (so-called “flapping”) of the air jet during the spray gun operation. Flapping is caused by instabilities in the liquid paint discharged from the spray gun. Flapping is undesirable because it can result in an uneven distribution of paint droplets and reduce the overall transfer efficiency of the spray-gun (i.e. the amount of paint droplets adhering to a surface compared to the overall amount of paint droplets that are discharged from the spray-gun). Therefore, the invention provides for an improved quality of paint distribution with savings in efficiency.

Furthermore, spray turbulence characteristics of the discharged atomising air jet can be controlled by modifying the geometry of the protrusions. Reducing the turbulence in the discharged atomising air jet increases the overall transfer efficiency of the spray-gun.

Optionally, the rim region is annular.

Optionally, at least some of the plurality of protrusions have axially outward portions that extend radially inward. Said axially outward portions may extend towards the centre of the atomising air outlet. When the axially outward portions of the protrusions extend radially inward, the atomising air flow is directed to penetrate a paint jet, in particular, where the paint jet is emitted from a location radially inward of the rim. This improves the stability of the resulting atomised paint jet thereby enabling a straight exit profile to be maintained for a longer period of time. As a result, application of the paint spray to a surface is better controlled and repeatable. However in some embodiments, the portions of the protrusions do not necessarily extend radially inwards (i.e. an inner surface of the protrusions is substantially parallel with the centreline of the outlet).

Optionally, the valleys each comprise a curved surface between the protrusions.

Optionally, the valleys extend radially from the centre of the outlet.

Optionally, each protrusion comprises an apex that extends radially outwards from the centre of the atomising air outlet.

Optionally, the radial width of each of the plurality of protrusions increases with distance from the atomising air outlet.

Optionally, the plurality of protrusions is between 8 and 16 protrusions.

Optionally, the air cap nozzle is further configured for attachment to a paint spray-gun. When attached, a paint nozzle of the paint spray-gun may be substantially centroid to the air cap nozzle outlet.

Optionally, the air cap nozzle further comprises one or more horns protruding from an external surface of the air cap, each of the one or more horns configured to discharge an auxiliary air jet towards an atomisation region downstream of the atomising air outlet.

### BRIEF DESCRIPTION OF THE FIGURES

FIG. 1a shows an airflow profile (as viewed facing upstream) of discharging atomising air from an existing air cap nozzle without protrusions.

FIG. 1b shows an airflow profile (as viewed facing upstream) of discharging atomising air from an air cap nozzle comprising protrusions.

FIG. 2a schematically shows the static pressure difference between ambient air and atomising air discharged from the air cap nozzle of FIG. 1a.

FIG. 2b schematically shows the static pressure difference between ambient air and atomising air discharged from the air cap nozzle of FIG. 1b.

FIG. 3a shows a flow visualisation pattern of air discharging from the air cap nozzle of FIG. 1a when viewed axially at four different axial locations downstream from the air cap nozzle outlet.

FIG. 3b shows a flow visualisation pattern of air discharging from the air cap nozzle of FIG. 1b when viewed axially at different axial locations downstream from the air cap nozzle outlet.

FIG. 4a shows a flow visualisation pattern of air discharging from the air cap nozzle of FIG. 1a when viewed laterally to the discharged air flow.

FIG. 4b shows a flow visualisation pattern of air discharging from the air cap nozzle of FIG. 1b when viewed laterally to the discharged air flow.

FIG. 5a shows the air cap nozzle of FIG. 1b comprising horns for discharging auxiliary air flows.

FIG. 5b shows a top-down view of the air cap nozzle of FIG. 5a.

FIG. 6 shows a close-up view of the outlet of the air cap nozzle of FIG. 1b.

### DETAILED DESCRIPTION

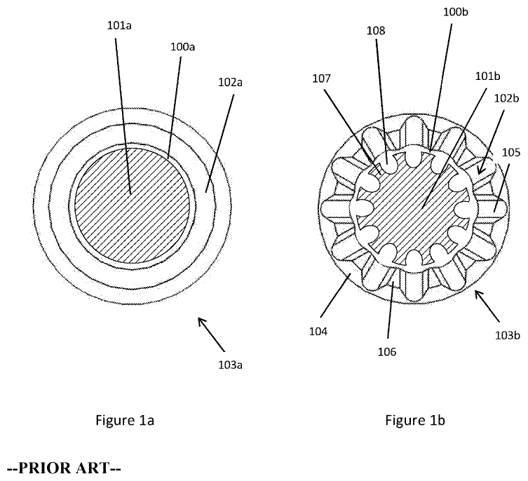

With reference to FIG. 1a there is shown an airflow profile of an air jet 101a discharged from an air cap nozzle 103a (also referred to as an “air nozzle”) having a conventional circular rim 102a. The air jet 101a discharges via the air nozzle outlet 100a. It can be observed that the airflow profile of air jet 101a is circumferentially uniform. The air jet discharged from the air nozzle of FIG. 1a having conventional rim 102a entrains ambient air after the air jet 101a has been discharged from the air nozzle 103a.

With reference to FIG. 1b there is shown an airflow profile of an air jet 101b discharged from an air nozzle 103b according to embodiments of the invention. Air nozzle 103b has a rim 102b (also referred to as a rim region) comprising protrusions 104. Each protrusion has an apex 106 separated by the apex of the adjoining protrusion by a valley 105. The rim 102b surrounds air nozzle outlet 100b (also referred to as an atomising air outlet). In the shown embodiment, the apex 106 of each protrusion 104 extends radially away from the centre of the air nozzle outlet 100b. The protrusions may be called “chevrons” or “saw-tooth”. It can be observed that the airflow 101b is substantially converged to locations 107 radially inward of each protrusion 104. Therefore, there are gaps 108 in the airflow 101b at locations immediately radially inward from the valleys 105 (i.e. in between the protrusions 104).

In the nozzle of FIG. 1b, entrainment of the air jet 101b commences before the air jet has exited the air nozzle 103b (i.e. entrainment commences in the valleys 102b before the air of the air jet 101b is downstream of the protrusions 106).

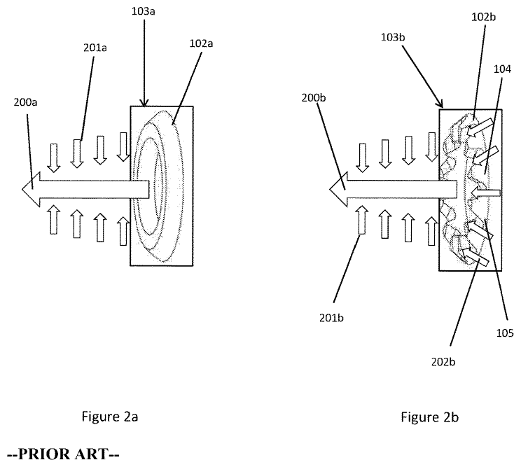

With reference to FIG. 2a the direction of the air jet discharged from the air nozzle outlet 103 a of FIG. 1a is shown by arrow 200a. The static pressure difference between the ambient air and discharged air jet is indicated by arrows 201a.

With reference to FIG. 2b, there are shown protrusions 104 surrounding the air nozzle outlet. There is a static pressure difference between the ambient air and discharged air jet 200b as indicated by arrows 201b. This static pressure difference is similar to that shown with reference to FIG. 2a. However, there is an additional static pressure difference generated by the protrusions 104 as indicated by arrows 202b. The additional static pressure difference forms small radial incursion jets within the nozzle 103b, which generate counter-rotating vortex pairs (not shown in FIG. 2b).

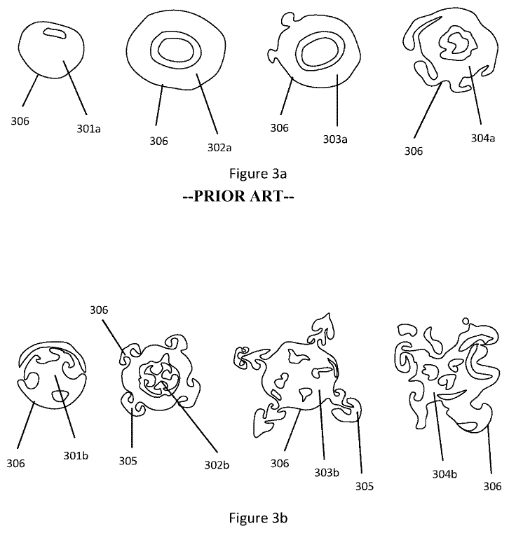

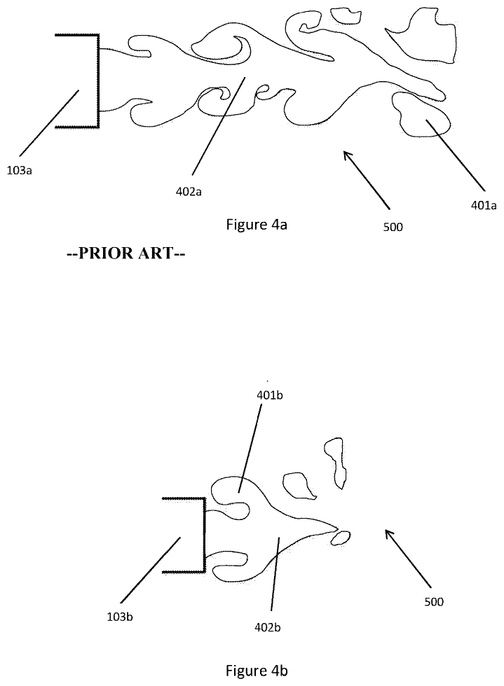

With reference to FIG. 3a, flow visualisation patterns 301a, 302a, 303a, 304a are shown of air discharging from the air cap nozzle (i.e. the air jet) at axial locations downstream from the air nozzle outlet of FIG. 1a (in order of distance from the air nozzle outlet). The internal contours shown in FIGS. 3a to 4b relate to outlines of flow visualisation marker features within the air jet that are observed. Of greatest significance to the invention are the outermost contours 306 delimiting the air jet from the ambient air. It is observed that the air jet from the air nozzle of FIG. 1a does not develop significant counter-rotating vortex pairs. Any mixing between the air jet and ambient air remains minimal.

In contrast, and with reference to FIG. 3b, significant counter-rotating vortex pairs 305 are generated from the air nozzle of 1b. The counter-rotating vortex pairs can be observed with reference to the outermost contours 306 of the flow visualisations 301b, 302b, 303b, 304b that are taken downstream axial locations corresponding with those of FIG. 3a. As shown in FIG. 3b, the counter-rotating vortex pairs 305 propagate radially outwards from the air nozzle outlet. The vortex pairs cause greater mixing compared to air nozzles where no such vortex pairs are generated. The enhanced mixing between the discharged air jet and ambient air causes the peak velocity of the discharged air jet (and therefore turbulence) to be reduced more quickly resulting in a reduction in noise. In particular, flow visualisation 304b indicates a much greater mixing between the air jet and ambient air compared to that shown in flow visualisation 304a of FIG. 3a. The greater mixing can be particularly observed with reference to the outermost contours 306 of FIG. 3b in comparison to those of FIG. 3a.

With reference to FIGS. 4a and 4b there are shown sideways flow visualisations of the discharged air jet 500 from the nozzles 103a, 103b (without and with protrusions respectively). The influence of the counter-rotating vortex pairs discussed above on the flow of the discharged air from the nozzle can be observed.

With reference to FIG. 4a, the “neck” portion 402a of the discharged air jet is relatively thick. The neck portion 402a is susceptible to fluctuations (i.e. so-called flapping as discussed above).

FIG. 4b shows a significantly thinner neck portion 402b. The neck portion is thinned due to the effect of the counter-rotating vortex pairs. The thinner neck portion 402b means that there is less fluctuation of the neck portion. In particular, the fluctuations 401b cease at a point significantly upstream from where the fluctuations 401a from the air nozzle of FIG. 4a cease. In other words, the frequency and altitude of fluctuations 401b are reduced. This is due to the influence of the counter-rotating vortex pairs in the air jet generated due to the protrusions. The reduced fluctuations improve the trajectory of small paint droplets and increases overall transfer efficiency of the spray-gun.

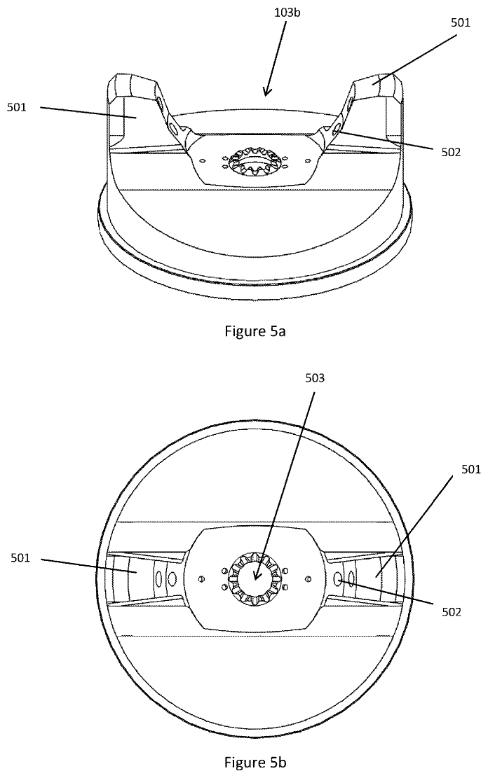

With reference to FIGS. 5a and 5b there is shown an air cap nozzle 103b such as that shown in FIG. 1b. The air cap nozzle additionally comprises two horns 501. The horns include auxiliary air outlets 502 for discharging auxiliary air jets to a region downstream of the outlet 503 of the air cap nozzle 103b. The auxiliary air jets serve to squeeze the discharged air jet towards a centrally discharged paint jet (not shown) thereby generating a paint spray pattern. The paint spray pattern can be adjusted by altering the geometry of the horns.

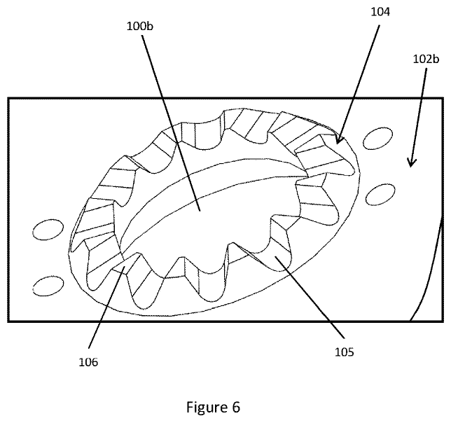

With reference to FIG. 6 there is shown a close-up of the rim 102b comprising protrusions 104. The rim 102b surrounds the air cap nozzle outlet 100b. The remaining features of FIG. 6 are discussed above with reference to FIG. 1b.

We claim:

1. A spray gun configured to atomise paint, comprising:
an air cap nozzle for discharging an atomising air jet for atomising paint from the spray gun, the air cap nozzle comprising a tip surface having an atomising air outlet and a rim region surrounding the atomising air outlet;
wherein: the rim region comprises a single continuous serrated portion formed by a plurality of protrusions that protrude axially outward from the rim region of the tip surface; and
the plurality of protrusions is separated by valleys configured to permit entrainment of ambient air by the atomising air jet, the entrained ambient air being drawn through the valleys, the permitted entrainment providing mixing between the entrained ambient air and the atomising air jet,
characterised in that the continuous serrated portion forms a trailing edge that impinges with the atomising air jet.

2. The air cap nozzle of claim 1 wherein the rim region is annular.

3. The air cap nozzle of claim 1 wherein at least some of the plurality of protrusions extend towards the centre of the atomising air outlet.

4. The air cap nozzle of claim 1 wherein the valleys each comprise a curved surface between the plurality of protrusions.

5. The air cap nozzle of claim 1 wherein the valleys extend radially from the centre of the atomising air outlet.

6. The air cap nozzle of claim 1 wherein each protrusion of the plurality of protrusions comprises an apex that extends radially outwards from the centre of the atomising air outlet.

7. The air cap nozzle of claim 1 wherein the radial width of each protrusion of the plurality of protrusions increases with distance from the atomising air outlet.

8. The air cap nozzle of claim 1 wherein the plurality of protrusions comprises between 8 and 16 protrusions.

9. The air cap nozzle of claim 1 further configured for attachment to an air spray-gun.

10. The air cap nozzle of claim 1 further comprising one or more horns protruding from an external surface of the air cap nozzle, each of the one or more horns configured to discharge an auxiliary air jet towards an atomisation region downstream of the atomising air outlet.
